(19) United States
(12) Patent Application Publication
(10) Pub. No.: US 2026/0230881 A1
(43) Pub. Date: Aug. 6, 2026

(54) METHODS AND APPARATUS FOR WIRELESS TRANSMIT AND RECEIVE UNIT (WTRU) INITIATED BEAM REPORTING BASED ON LOW POWER SIGNAL MONITORING

(71) Applicant: InterDigital Patent Holdings, Inc., Wilmington, DE (US)

(72) Inventors: Prasanna Herath, Laval (CA); Young Woo Kwak, Woodbury, NY (US); Moon IL Lee, Melville, NY (US)

(73) Assignee: InterDigital Patent Holdings, Inc., Wilmington, DE (US)

(21) Appl. No.: 19/047,570

(22) Filed: Feb. 6, 2025

(51) Int. Cl. H04W 24/10; H04B 17/318

(52) U.S. Cl. CPC H04W 24/10; H04B 17/328

(57) ABSTRACT

A method implemented by a wireless transmit/receive unit (WTRU) having a first radio and a second radio is disclosed. The method may comprise monitoring one or more reference signals received by the second radio and performing at least one measurement of the one or more references signals received by the second radio. The method may also comprise detecting an occurrence of a beam reporting event based on the at least one measurement of the one or more reference signals and determining a time period from the occurrence of the beam reporting event to receive a next reference signal at the first radio based on the first configuration information. Further, the method may comprises transmitting, via the first radio, a beam report for the beam reporting event to the network based on a comparison of the time period to a time threshold.

### BACKGROUND

In current and next generation wireless systems, low-power wake-up signals (LP-WUS) are a feature designed to improve the energy efficiency of devices, particularly user equipment (UE) and/or Wireless transmit and Receive Units (WTRUs) like smart phones, IoT devices, and other battery powered equipment. A LP-WUS allows devices to conserve battery life by reducing the need for continuous monitoring of control channels. These signals enable devices to transition from a low-power state to an active state only when necessary. The LP-WUS is a specific signal sent before control channels (e.g., physical downlink control channel (PDCCH)) and/or data channels are transmitted. The LP-WUS alerts the device to wake-up and prepare for potential communication on a PDCCH. A device, for example a WTRU, may have two radios, one radio may be a low-power radio or low-power wake-up radio (LR) and the other radio may be a main radio (MR) that is activated by the low-power radio.

When the MR of a WTRU is active, the WTRU may transmit or receive a physical channel or reference signal according to at least one spatial domain filter, also referred to as a “beam”. Conventional beam selection is controlled by the base station (e.g., gNB) based on WTRU reporting, such as channel state information (CSI) reporting. For example, the base station may configure or activate periodic or semi-persistent beam reporting or trigger aperiodic beam reporting to determine best or preferred beam for data and control signal transmissions. The WTRU may be configured with measurement resources, e.g., reference signals (RSs) and these resources are linked to a CSI reporting configuration. Based on the CSI reporting configuration, the WTRU may measure the resources and report the measurement results via the CSI reporting configuration. For the case of aperiodic reporting, the base station may trigger a measurement reporting using a downlink control indication (DCI). This conventional beam or channel state information (CSI) reporting from a WTRU may be susceptible to latency and overhead issues, which may result in lower efficiency. This approach also typically requires large uplink (UL) reporting overhead to transmit beam reports and control signaling overhead to trigger and/or configure beam reporting.

Further, beam measurements of a WTRU may be reported upon detecting events. However, the events are usually detected based on measurements of main radio (MR) beams. As such, event detection of MR beam measurements may not suitable for low-power wake-up signal (LP-WUS) monitoring. For example, to perform MR beam measurements, the main radio (MR) of a WTRU may need to be turned on regularly. Turning on MR regularly can increase power consumption of the WTRU. Frequent switching between the MR and the LR can also reduce WTRU throughput as the WTRU may not be available for data reception and transmission while performing radio switching.

### SUMMARY

Various aspects are disclosed for efficient beam management with reduced latency and overhead by performing WTRU initiated beam measurement reporting (WTRUIBR). Since the WTRU may have better and more-timely knowledge of beam quality and variations, supporting WTRU-initiated beam reporting (WTRUIBR) can lead to more timely beam reports yet with reduced reporting overhead. With WTRUIBR, if the WTRU determines an event (e.g., current beam(s) quality becomes poor), the WTRU can trigger beam reporting without the network needing to configure or trigger frequent reporting. Further, the throughput of the WTRU may be increased by avoiding frequency switching between the main radio (MR) or transceiver and the low power radio (LR) or transceiver for performing beam measurements.

In one aspect, a method implemented by a wireless transmit/receive unit (WTRU) having a first radio and a second radio is disclosed. The method may comprise receiving, from a network, first configuration information for monitoring signals using the first radio, and receiving, from the network, second configuration information for monitoring signals using the second radio. The method may also comprise monitoring one or more reference signals received by the second radio based on the second configuration information, and performing at least one measurement of the one or more references signals received by the second radio. Further, the method may comprise detecting an occurrence of a beam reporting event based on the at least one measurement of the one or more reference signals, and determining a time period from the occurrence of the beam reporting event to receive a next reference signal at the first radio based on the first configuration information. Additionally, the method may comprises transmitting, via the first radio, a beam report for the beam reporting event to the network based on a comparison of the time period to a time threshold.

In another aspect, a first wireless transmit/receive unit (WTRU) is disclosed. The WTRU may comprise a first radio, a second radio, and a processor. The processor may be configured to receive, from a network, first configuration information for monitoring signals using the first radio and to receive, from the network, second configuration information for monitoring signals using the second radio. The processor may also be configured to monitor one or more reference signals received by the second radio based on the second configuration information and determine at least one measurement of the one or more references signals received by the second radio. Further, the processor may be configured to detect an occurrence of a beam reporting event based on the at least one measurement of the one or more reference signals and to determine time period from the occurrence of the beam reporting event to receive a next reference signal at the first radio based on the first configuration information. Additionally, the processor may be configured to transmit, via the first radio, a beam report for the beam reporting event to the network based on a comparison of the time period to a time threshold.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an illustration of simplified receiver architecture of a WTRU utilizing a low-power wake-up radio or transceiver;

FIG. 3 illustrates a signaling diagram of an event detection procedure, in accordance with an exemplary implementation;

FIG. 4 illustrates a signaling diagram of an event detection procedure, in accordance with another exemplary implementation;

FIG. 5 illustrates a signaling diagram of an event detection procedure, in accordance with another exemplary implementation; and

FIG. 6 illustrates a flow diagram of a method for detecting a beam reporting event based on low power radio (LR) beam measurements.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

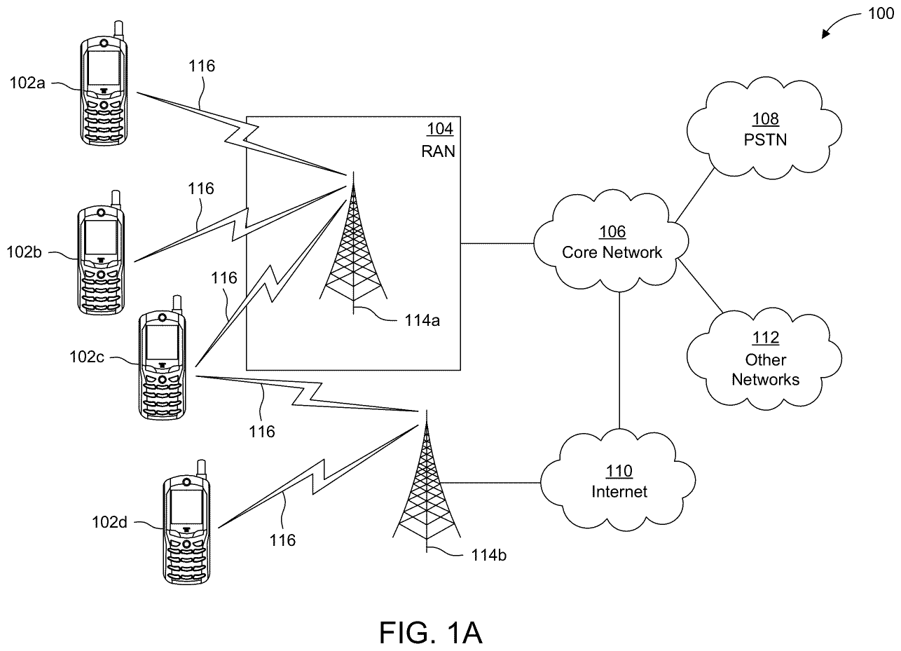

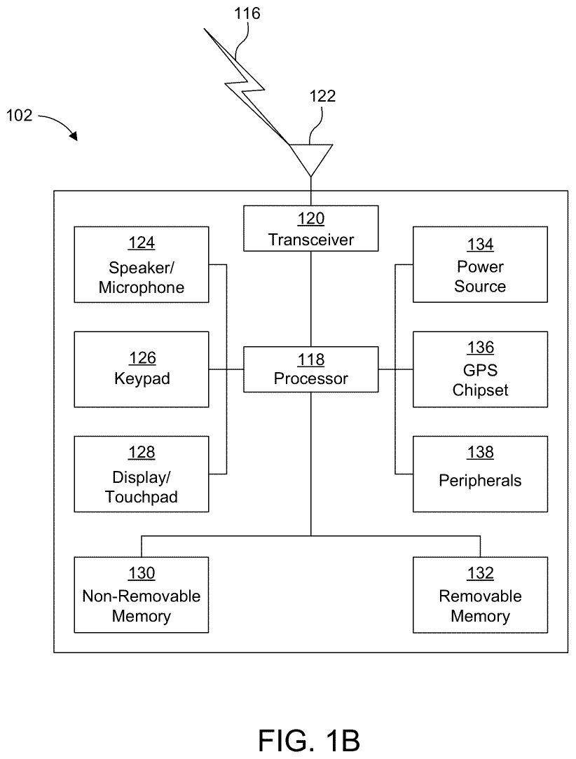

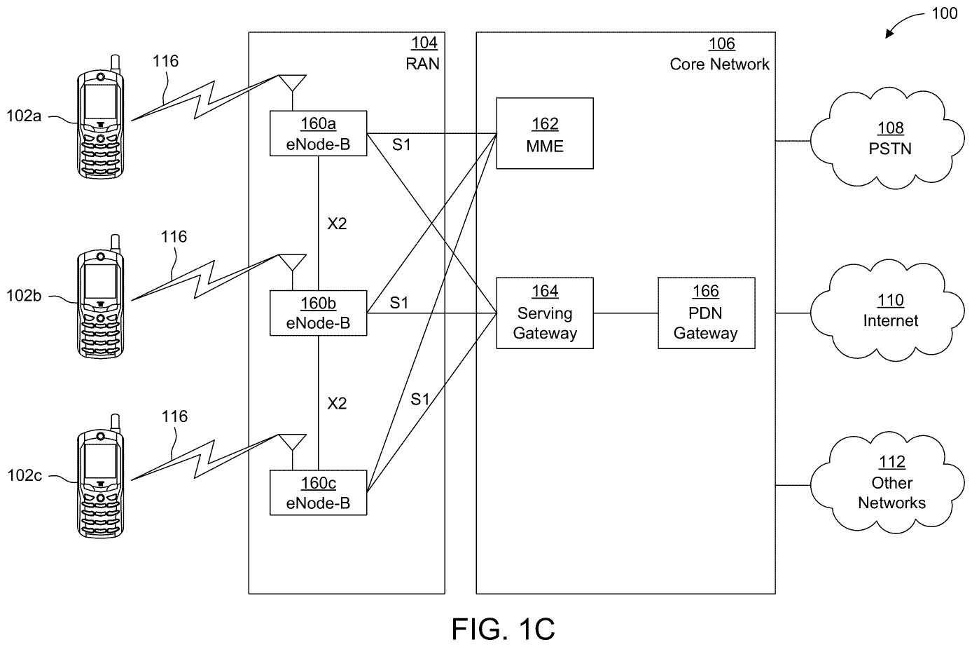

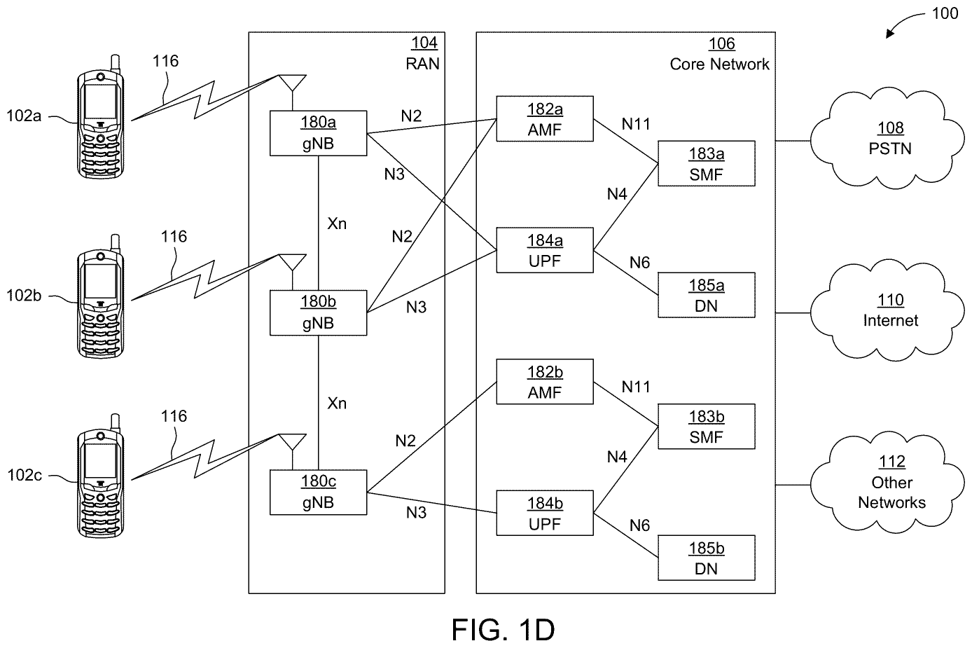

The methods, procedures, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114 b and the WTRUs 102 c, 102 d may implement a radio technology such as IEEE 802.11 to establish a wireless local area network (WLAN). In an embodiment, the base station 114b and the WTRUs 102 c, 102 d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000,WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80 +80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may include a first radio and a second radio. The first radio may be called a main radio (MR) and the second radio may be called a low-power radio (LR) or a low power wake-up radio (LP-WUR). The WTRU may monitor and receive a wake-up signal (WUS) and one or more signals (e.g., a low-power synchronization signal (LP-SS)) which may assist in the reception of the WUS via the second radio (e.g., a low-power or ultra-low power radio). The WUS may be called a low-power WUS (LP-WUS). Received WUS (e.g., an LP-WUS), for example via the second radio or LR, may trigger wake-up or use of the first radio or MR of the WTRU for data and/or control signal transmission and/or reception. This configuration has the potential to reduce the power consumption of wireless devices.

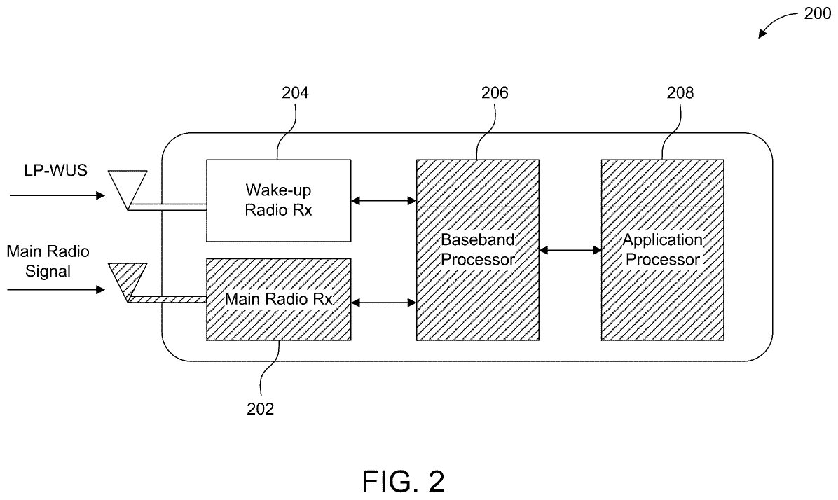

FIG. 2 illustrates a simplified receiver architecture of a WTRU 200 utilizing a low-power wake-up radio or receiver. As shown in FIG. 2, the WTRU 200 may have a first radio 202 and a second radio 204. The first radio 202 may be a main radio (MR) and the second radio 204 may be a low power radio (LR) (e.g., a low-power or ultra-low wake-up radio (LP-WUR)). The first radio 202 may be configured to receive a main radio signal and the second radio 204 may be configured to receive a LP-WUS. The type of the second radio 204 may be an OOK-based radio or receiver, an OFDM-based radio or receiver, or any other suitable receiver. The WTRU 200 may monitor and receive a low power wake-up signal (LP-WUS) via the second radio 204 or LR. The LP-WUS may be received while the WTRU 200 is in a low-power state and used to wake-up the first radio 202 or MR. The second radio 204 can reduce power consumption of the WTRU 200. For example, the second radio 204 can monitor wake-up signals (WUSs) and trigger and/or wake-up the first radio 202 dedicated for data and control signal transmission and/or reception.

The first radio 202 (e.g., MR) and the second radio 204 (e.g., LR) are each in communication with a baseband processor 206, which is in communication with an application processor 208. The LP-WUS may be processed by the baseband processor 206 and application processor 208. Signal processing of the LP-WUS may be performed to reliably determine that the signal is intended for the WTRU and the signal is a wake-up signal. The application processor 208 may trigger the baseband processor 206 to wake-up the first radio 202 (e.g., MR). Based on the processing of the LP-WUS by the baseband processor 206 and the application processor 208, the first radio 202 is triggered to wake-up or turn on. The first radio 202 may then transmit and receive one or more main radio signals. For example, the WTRU 200 may have the first radio 202 (e.g., MR) turned off to reduce power consumption. Upon receiving a LP-WUS, the second radio 204 (e.g., LR) may trigger the first radio 202 (e.g., MR) to wake-up and start monitoring a channel of a wireless network. For example, the first radio 202 (e.g., MR) may start to monitor a physical downlink control signal (PDCCH), listen for paging occasions, and/or transition from an idle or inactive mode to an active mode.

The operation of the WTRU 200 based on indications and/or channels, and/or signals received via the second radio 204 or LR may be referred to herein as operating in a “LP mode”. The terms operating in a LP mode, monitoring LP signals, LP signal monitoring, and LP-WUS monitoring may be interchangeably used. Further, the terms “reference signal (RS)” and “beam” may be interchangeable used. For example, a beam associated with a LR may be referred to as an LR RS. In another example, a beam associated with a MR may referred to as an MR RS.

While the WTRU 200 is operating in a LP mode, the WTRU 200 may perform one or more of the following procedures. For example, the WTRU 200 may monitor for one or more LP signals via the second radio 204 or LR. One or more LP signals may include a LP-WUS, a LP-SS, or any signal received via the second radio 204 or LR. The WTRU 200 may also keep the first radio 202 or MR in a power saving state (e.g., deep sleep state, light sleep state, etc.). The WTRU 200 may skip one or more operations performed via the first radio 202 or MR (e.g., skip PDCCH monitoring in resources configured by discontinuous reception (DRX) configuration). The WTRU 200 may wake-up the first radio 202 or MR (e.g., for monitoring and receiving PDCCHs) based on reception of wake-up indication via a LP-WUS. Waking up the first radio 202 or MR may move the WTRU 200 out of the LP mode.

The WTRU 200 may (e.g., periodically) wake-up the first radio 202 or MR and/or may resume using the first radio 202 or MR for a limited duration (e.g., time duration preconfigured via one or more of radio resource control (RRC) signaling, medium access control-control element (MAC-CE) indication, or downlink control indication (DCI) indication). Once the WTRU 200 wakes up the first radio 202 or MR or resumes using the first radio 2020 or MR, the WTRU 200 may monitor for one or more signals or channels (e.g., channel state information-reference signal (CSI-RS), synchronization signal blocks (SSBs), PDCCH) and/or may transmit one or more signals or channels (e.g., SRS, CSI reports, PRACH preamble). After the limited duration, the WTRU 200 may stop using the first radio 202 or MR (e.g., place the MR in a power saving state) and resume to use the second radio 204 or LR. During the limited duration, the WTRU 200 may monitor LP signals via the second radio 204 or LR or skip monitoring LP signals.

The WTRU 200 may initiate beam reporting based on events detected by using LR Beam measurements. For example, the WTRU 200 may monitor LP signals and may determine if any event triggering beam reporting has occurred based on LR beam measurements. Upon detecting an occurrence of an event triggering beam reporting, the WTRU 200 may transmit LR beam measurements and/or the MR beam measurements and/or detected event(s). Transmitting beam measurements may depend on one or more of, detection or non-detection of any events, event detected by LR beam measurements if any event is detected, and time to receive/measure MR beams, etc. To this end, the WTRU 200 may use one or more of the following methods/procedures/solutions.

To support detecting events for WTRU initiated beam measurement reporting (WTRUIBR) based on LR beam measurements and/or WTRU-initiated beam reports associated with detected one or more WTRUIBR events, the WTRU 200 may receive one or more of the following configurations and/or indications from the base station (e.g., gNB). The WTRU 200 may receive the one or more of the configurations and/or indications via one or more of RRC signaling, MAC-CE indication, and DCI indication.

The WTRU 200 may receive a CSI report configuration (LR-CSI report configuration) associated with LR measurements. The WTRU 200 may also receive one or more CSI report configurations associated with MR beam measurements. For example, the WTRU 200 may receive first and second MR-CSI report configurations where the first and second MR-CSI report configurations may differ in terms of one or more associated parameters/configurations.

The first MR-CSI reporting configuration may be associated with reporting signal quality (e.g., L1-RSRP) of M₁ beams. The second MR-CSI reporting configuration may be associated with reporting signal quality (e.g., L1-RSRP) of M₂ beams, where M₁<M₂. The first MR-CSI report configuration may be associated with reporting identities (e.g., CSI-RS resource indicators (CRIs)s of one or more beams) of one or more beams (e.g., preconfigured (e.g., via one or more RRC signaling, MAC-CE indication, DCI indication) and/or a number of beams with highest signal quality (e.g., L1-RSRP)). The second MR-CSI report configuration may be associated with reporting identities and beam quality (e.g., L1-RSRP) measurements of one or more beams (e.g., preconfigured (e.g., via one or more RRC signaling, MAC-CE indication, DCI indication) number of beams with highest signal quality (e.g., L1-RSRP)).

The WTRU 200 may also receive LR beams (e.g., current LR beam and new LR beams) for detecting the occurrence of one or more events (LR-WTRUIBR events) associated with WTRUIBR based on LR beam measurements. In an example, the WTRU 200 may receive configuration for a current LR beam and one or more new LR beams from the base station or gNB. For example, The WTRU 200 may be configured with a set of LR beams.

The WTRU 200 may determine a current LR beam and new LR beams from a configured set of LR beams based on a preconfigured (e.g., via one or more RRC signaling, MAC-CE indication, DCI indication) rule/a rule known to both the WTRU 200 and the base station or gNB. For example, the WTRU 200 may receive (e.g., via one or more of RRC signaling, MAC-CE indication, DCI indication) a set of LP-SSs.

The WTRU 200 may receive a bit map where each bit in the bitmap corresponds to a LP-SS in a configured (e.g., via one or more RRC signaling, MAC-CE indication, DCI indication) LP-SS burst or transmitted LP-SSs in a configured LP-SS burst. The WTRU 200 may determine a current LR beam from the first LP-SS in a set of received LP-SSs. The WTRU 200 may determine new LR beams from the remaining LP-SSs in set of received LP-SSs.

The WTRU 200 may determine a current LR beam and new LR beams based on configured/activated TCSI states and preconfigured (e.g., via one or more of RRC signaling, MAC-CE indication, DCI indication) association between LR and MR beams. For example, the WTRU 200 may determine a MR beam based on MR RSs configured with quasi co-location (QCL) type set to ‘typeD’ in an activated TCI state for PDCCH monitoring. The WTRU 200 may also determine a current LR beam based on the determined beam and preconfigured association between the MR and the LR beams. If one or more MR beams are associated with one LR beam, the WTRU 200 may determine a LR beam associated with the determined MR beam as the current LR beam. The WTRU 200 may determine a set of MR beams based on activated/configured TCI states for the WTRU 200. For example, the WTRU 200 may determine a set of MR beams based on MR RSs configured with quasi co-location (QCL) type set to ‘typeD’in the activated/configured TCI states.

The WTRU 200 may determine a set of new LR beams based on the determined set of MR beams and preconfigured association between MR and LR beams. If each MR beam associated with more than one LR beams, the WTRU 200 may determine a current LR beam to be the LR beam based on one or more of a beam index/RS index (e.g., LR beam with the lowest or highest beam/RS index), and/or arrival time of LR beams (e.g., LR beam/RS received first or LR beam/RS received last).

The WTRU 200 may also receive one or more LR-WTRUIBR events. For example, the WTRU 200 may receive (e.g., via one or more RRC signaling, MAC-CE indication, DCI indication) a first threshold for beam quality of a current LR beam. The WTRU 200 may determine that a first LR-WTRUIBR event has occurred if the signal quality of the current LR beam is lower than a preconfigured threshold. In an example, the WTRU 200 may receive (e.g., via one or more RRC signaling, MAC-CE indication, DCI indication) a second threshold for beam quality (e.g., L1-RSRP) of a current LR beam and a threshold for a number (N≥1) of LR beams exceeding a signal quality (e.g., L1-RSRP) of current LR beam. The WTRU 200 may determine that the second LR-WTRUIBR event has occurred if the signal quality (e.g., L1-RSRP) of the current LR beam exceeds a second threshold on beam quality and a signal quality (e.g., L1-RSRP) of at least N new LR beams exceeds the signal quality (e.g., L1-RSRP) of current LR beam.

The WTRU 200 may receive first and/or second UL resources. In an example, the WTRU 200 may be semi-statically configured with (e.g., periodic) first and second UL resources (e.g., first and second PUCCH resources via RRC signaling). The WTRU 200 may also be semi-statically configured with (e.g., periodic) a first UL resource from the base station or gNB (e.g., via RRC signaling). The WTRU 200 may dynamically receive a configuration for a second UL resource based on an indication (e.g., 1 bit indication in a PUCCH) transmitted by using a first UL resource.

The WTRU 200 may receive a configuration for reflection based communication (e.g., backscatter communication) which may include one or more of the following: a threshold on minimum signal quality (e.g., L1-RSRP); and a time window for reporting beam measurements by using reflection based communication. For example, the WTRU 200 may receive a configuration of: a time window defined by an offset (e.g., in slots/symbols/frames/ms) with respect to reception occasion of LR beams associated with LR-CSI report configuration and duration (e.g., in slots/symbols/frames/ms); a set of sequences (e.g., binary sequence) where each sequence associated with each beam among LR beams is associated with a LR-CSI report configuration; and/or a setoff time offset and/or a set of durations where each combination of time offset and duration associated with each among LR beams associated with LR-CSI report configuration. Further, the WTRU 200 may receive first time duration (Tₘᵢₙ) and second time duration (Tₘₐₓ) thresholds (e.g., in terms of ms, number of slots, frames, symbols).

When detecting occurrences of LR-WTRUIBR events, the WTRU 200 may receive configurations and/or indications (e.g., via one or more RRC signaling, MAC-CE indication, DCI indication) for starting to monitor LP signals (e.g., monitor for and receive LP signals (e.g., LP-WUS, LP-SS) and one or more LR beams and/or LR RSs). For example, the WTRU 200 may monitor for and receive a LP-WUS while the WTRU 200 (e.g., periodically) may measure signal quality (e.g., L1-RSRP) of a current LR beam and one or more new LR beams. Based on the measured signal quality (e.g., L1-RSRP) of the current LR beam and the one or more new LR beams, the WTRU 200 may determine the occurrence of one or more LR-WTRUIBR events.

The WTRU 200 may determine an occurrence of a first LR-WTRUIBR event based on (e.g., periodically) a measured signal quality of a current LR beam and a first threshold for beam quality. For example, the WTRU 200 may determine the number of instances that a signal quality (e.g., L1-RSRP) of a current LR beam falls below a first threshold for beam quality within a preconfigured (e.g., via one or more of RRC signaling, MAC-CE indication, DCI indication) time window (e.g., a moving time window in the immediate past defined in terms of number of LR beam monitoring occasions, ms, number of slots, frames, or symbols, etc.). If the number of detected instances exceeds a preconfigured (e.g., via one or more of RRC signaling, MAC-CE indication, DCI indication) threshold, the WTRU 200 may determine that the first LR-WTRUIBR event has occurred. The WTRU 200 may also determine that the first LR-WTRUIBR event has occurred if the signal quality of the current LR beam falls below the first beam quality threshold in a preconfigured (e.g., via one or more RRC signaling, MAC-CE indication, DCI indication) number (≥1) of consecutive LR beam monitoring occasions.

The WTRU 200 may determine an occurrence of a second LR-WTRUIBR event based on (e.g., periodically) a measured signal quality (e.g., L1-RSRP) of a current LR beam, measured signal quality (e.g., L1-RSRP) of new LR beams, second beam quality thresholds, and thresholds of a number of beams N. In an example, the WTRU 200 may determine a number of instances of signal quality (e.g., L1-RSRP) of at least N number of new LR beams exceed a signal quality (e.g., L1-RSRP) of a current LR beam while the signal quality (e.g., L1-RSRP) of the current LR beam exceeds a second beam quality threshold within a preconfigured (e.g., via one or more RRC signaling, MAC-CE indication, DCI indication) time window (e.g., a moving time window in the immediate past defined in terms of number of LR beam monitoring occasions, ms, number of slots, frames, or symbols, etc.). If the number of instances exceeds a preconfigured (e.g., via one or more RRC signaling, MAC-CE indication, DCI indication) threshold, the WTRU 200 may determine that a second LR-WTRUIBR event has occurred.

The WTRU 200 may determine a number of consecutive instances of signal quality (e.g., L1-RSRP) of at least N number of new LR beams exceed a signal quality (e.g., L1-RSRP) of a current LR beam while a signal quality (e.g., L1-RSRP) of the current beam exceeds a second beam quality threshold. If the number of detected instances exceeds a preconfigured (e.g., via one or more of RRC signaling, MAC-CE indication, DCI indication) threshold, the WTRU 200 may determine that a second LR-WTRUIBR event has occurred.

The WTRU 200 may report beam measurements and/or information on a detected LR-WTRUIBR event (e.g., first LR-WTRUIBR event, second LR-WTRUIBR event) based on one or more of the following. For example, the WTRU 200 may determine a radio (e.g., LR or MR) for reporting beam measurements and/or reporting detected LR-WTRUIBR events to the base station (e.g., gNB) based on detection or non-detection of LR-WTRUIBR events. If the WTRU 200 detects an occurrence of an LR-WTRUIBR event, the WTRU 200 may determine to use the MR. If the WTRU 200 does not detect an occurrence of at least one LR-WTRUIBR event, the WTRU 200 may determine to use the LR. For example, the WTRU 200 may report beam measurements and/or information on detected LR-WTRUIBR events based on reflection based communication (e.g., backscatter communication).

The WTRU 200 may also determine a radio (e.g., LR or MR) for reporting beam measurements and/or reporting detected LR-WTRUIBR events to the base station (e.g., gNB) based on detected LR-WTRUIBR event(s). If the WTRU 200 detects an occurrence of a first LR-WTRUIBR event, the WTRU 200 may determine to use the MR. If the WTRU 200 detects an occurrence of a second LR-WTRUIBR event, the WTRU 200 may determine to use the LR. Further, the WTRU 200 may determine a radio (e.g., LR or MR) for reporting beam measurements and/or reporting detected LR-WTRUIBR events to the base station (e.g., gNB) based on proximity to the base station.

The WTRU 200 may determine whether the WTRU 200 is sufficiently close to the base station (e.g., gNB) for using the LR for beam reporting based on LR beam measurements. For example, the WTRU 200 may measure signal quality (e.g., L1-RSRP) of a set of preconfigured (e.g., via one or more RRC signaling, MAC-CE indication, DCI indication) LP-SSs. If the highest measured signal quality (e.g., L1-RSRP) among measured LP-SSs ≥a preconfigured (e.g., via one or more of RRC signaling, MAC-CE indication, DCI indication) threshold, the WTRU 200 may determine that the WTRU 200 is sufficiently close to the base station (e.g., gNB) for transmitting a beam report by using the LR. If the highest measured signal quality (e.g., L1-RSRP) among measured LP-SSs<the preconfigured threshold, the WTRU 200 may determine that the WTRU 200 is not close enough to the base station (e.g., gNB) for the LR. Therefore, the WTRU 200 may determine to use the MR.

The WTRU 200 may determine beam measurements and/or information on detected LR-WTRUIBR events to be reported based on one or more of the following. For example, beam measurements may include one or more of beam measurements (beam report for LR-WTRUIBR event) associated with a detected LR-WTRUIBR event, a beam report associated with MR-CSI report configurations, and/or a beam report associated with LR-CSI report configurations. The beam report for a LR-WTRUIBR event may include one or more detected LR-WTRUIBR events (e.g., a first LR-WTRUIBR event, a second LR-WTRUIBR event, etc.), and/or a beam quality of the current beam and/or beam quality of one or more new LR beams.

The WTRU 200 may determine beam measurements and/or information on detected LR-WTRUIBR events to be reported based on the radio used for measurement reporting and/or reporting information on detected LR-WTRUIBR events. If the WTRU 200 determines to use the LR for reporting beam measurements (e.g., based on not detecting occurrence of any LR-WTRUIBR event), the WTRU 200 may report the identity (e.g., CRI) of the beam (best beam) with the highest measured signal quality (e.g., L1-RSRP) among a beam resource set associated with a LR-CSI report configuration.

The WTRU 200 may report the identity of the best beam to the base station or gNB by using reflection based communication (e.g., backscatter communication). If the WTRU 200 determines to use the MR for reporting beam measurements (e.g., based on detecting an LR-WTRUIBR event), the WTRU 200 may report beam reports for LR-WTRUIBR events and/or beam reports associated with one or more configured MR-CSI report configurations.

The WTRU 200 may also determine beam measurements and/or information on detected LR-WTRUIBR events to be reported based on a time (Tₙₑₓₜ) to receive MR RSs associated with MR-CSI report configurations from the detection of an LR-WTRUIBR event. For example, the WTRU 200 that detects an LR-WTRUIBR event may report a MR beam report associated with the MR-CIS report configuration based on the time (Tₙₑₓₜ) and configured thresholds (Tₘᵢₙ, Tₘₐₓ). For example, if Tₙₑₓₜ <Tₘᵢₙ or Tₙₑₓₜ>Tₘₐₓ, the WTRU 200 may report information on a detected LR-WTRUIBR event and/or a beam report a for LR-WTRUIBR event.

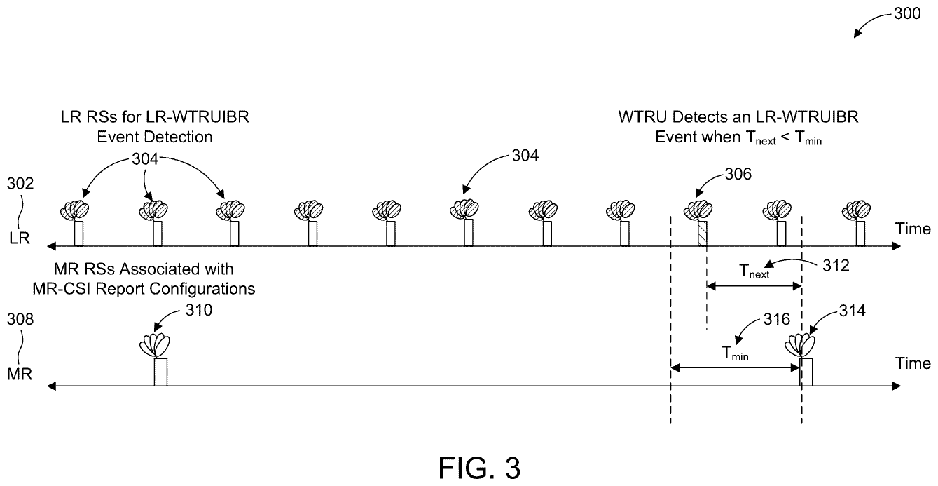

FIG. 3 illustrates a signaling diagram of an event detection procedure 300 when Tₙₑₓₜ<Tₘᵢₙ. As shown in FIG. 3, the low power radio (LR) 302 of a WTRU (e.g., WTRU 200) may monitor for reference signals (RFs) 304 (e.g., LR RSs) to detect a WTRU initiated beam measurement reporting (WTRUIBR) event 306. The main radio (MR) 308 of the WTRU may also monitor for reference signals (RFs) 310 (e.g., MR RSs). The WTRU may determine a time period Tₙₑₓₜ 312 from the occurrence of the WTRUIBR event 306 to receive a next reference signal 314 at the MR 308. The WTRU may also receive a minimum time threshold (Tₘᵢₙ) 316 to receive the next reference signal 314 at the MR 308.

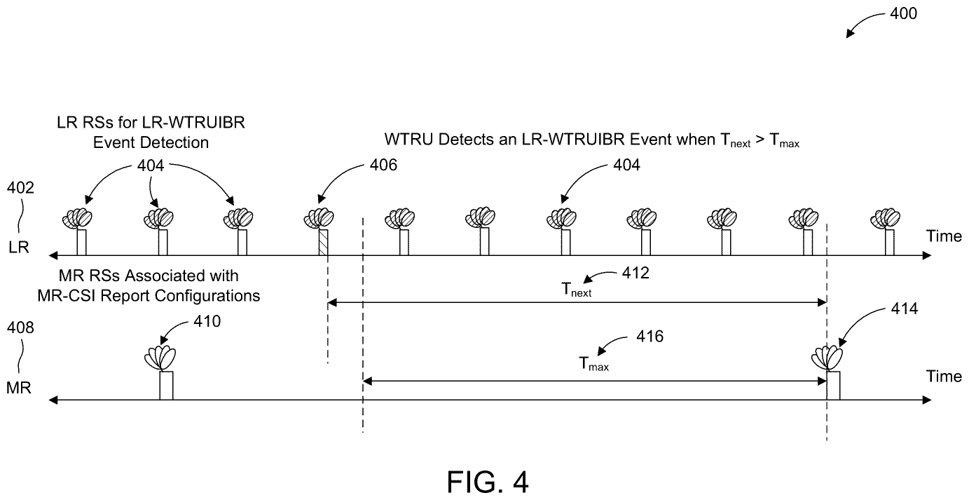

FIG. 4 illustrates a signaling diagram of an event detection procedure 400 when Tₙₑₓₜ >Tₘₐₓ. As shown in FIG. 4, the low power radio (LR) 402 of a WTRU (e.g., WTRU 200) may monitor for reference signals (RFs) 404 (e.g., LR RSs) to detect a WTRU initiated beam measurement reporting (WTRUIBR) event 406. The main radio (MR) 408 of the WTRU may also monitor for reference signals (RFs) 410 (e.g., MR RSs). The WTRU may determine a time period (Tₙₑₓₜ) 412 from the occurrence of the WTRUIBR event 406 to receive a next reference signal 414 at the MR 408. The WTRU may also receive a maximum time threshold (Tₘₐₓ) 416 to receive the next reference signal 414 at the MR 408.

If Tₘₐₓ≥Tₙₑₓₜ ≥Tₘᵢₙ, the WTRU 200 may report information on detected LR-WTRUIBR events and/or beam reports for LR-WTRUIBR events and/or beam reports associated with MR-CSI report configuration(s). Further, the WTRU 200 may determine beam measurements and/or information on detected LR-WTRUIBR events to be reported based on detected LR-WTRUIBR events.

When Tₘₐₓ≥Tₙₑₓₜ ≥Tₘᵢₙ, the WTRU 200 may report beam reports associated with detected LR-WTRUIBR events and/or one or more MR-CSI report configurations where the report configurations (e.g., first MR-CSI report configuration and/or second MR-CSI report configuration) are determined based on the detected LR-WTRUIBR events. If the WTRU 200 detects an occurrence of a first LR-WTRUIBR event, the WTRU 200 may report beam measurements for a first MR-CSI report configuration (e.g., the WTRU 200 reports measured beam quality of a set of beams associated with first MR-CSI report configuration). If the WTRU 200 detects an occurrence of a second LR-WTRUIBR event, the WTRU 200 may transmit a beam report for a LR-WTRUIBR event and a beam report for a second MR-CSI report configuration. If the WTRU 200 detects an occurrence of a first LR-WTRUIBR event, the WTRU 200 may report beam measurements for a first MR-CSI report configuration. If the WTRU 200 detects an occurrence of a second LR-WTRUIBR event, the WTRU 200 may report beam measurements for a second MR-CSI report configuration.

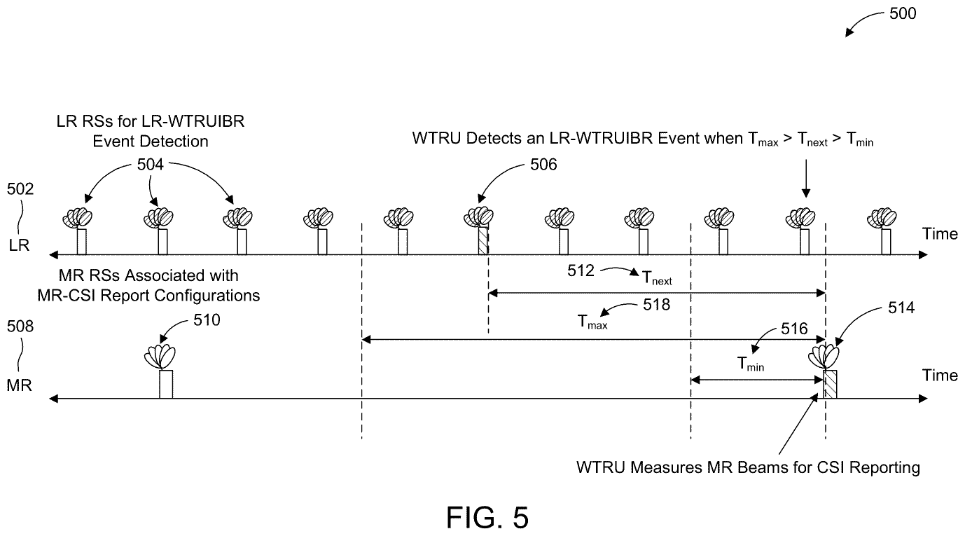

FIG. 5 illustrates a signaling diagram of an event detection procedure 500 when Tₘₐₓ≥Tₙₑₓₜ≥Tₘᵢₙ,. As shown in FIG. 5, the low power radio (LR) 502 of a WTRU (e.g., WTRU 200) may monitor for reference signals (RFs) 504 (e.g., LR RSs) to detect a WTRU initiated beam measurement reporting (WTRUIBR) event 506. The main radio (MR) 508 of the WTRU may also monitor for reference signals (RFs) 510 (e.g., MR RSs). The WTRU may determine a time period (Tₙₑₓₜ) 512 from the occurrence of the WTRUIBR event to receive a next reference signal 514 at the MR 508. The WTRU may also receive a minimum time threshold (Tₘᵢₙ) 516 to receive the next reference signal 514 at the MR 508. Further, the WTRU may receive a maximum time threshold (Tₘₐₓ) 518 to receive the next reference signal 514 at the MR 508.

Additionally, the WTRU 200 of FIG. 2 may determine beam measurements and/or information on detected LR-WTRUIBR events to be reported based on detecting or non-detecting occurrence of any LR-WTRUIBR events. If the WTRU 200 detects the occurrence of at least one LR-WTRUIBR event, the WTRU 200 may report information on the detected LR-WTRUIBR event and/or a beam report associated with MR-CSI report configuration(s) (e.g., by using MR signaling (e.g., PUCCH)). If the WTRU 200 does not detect an occurrence of any LR-WTRUIBR event, the WTRU 200 may report beam measurements for a LR-CSI report configuration (e.g., by using reflection based communication via LR).

The WTRU 200 may also determine beam measurements and/or information on detected LR-WTRUIBR events to be reported based on detecting or non-detecting occurrence of any LR-WTRUIBR event and gNB configuration and/or indication. If the WTRU 200 detects an occurrence of at least one LR-WTRUIBR event, the WTRU 200 may report information on the detected LR-WTRUIBR event and/or a beam report associated with a MR-CSI report configuration(s). If the WTRU 200 does not detect an occurrence of any LR-WTRUIBR event, the WTRU 200 may report beam measurements of a LR resource set associated with a LR-CSI report configuration based on a configuration and/or indication (e.g., via one or more RRC signaling, MAC-CE indication, DCI indication) received from the base station (e.g., gNB). If the WTRU 200 is not provided with a configuration associated with reflection based communication or the reflection based communication is configured (e.g., via RRC signaling) but not activated (e.g., via one or more RRC signaling, MAC-CE indication and/or DCI indication) by the base station (e.g., gNB), the WTRU 200 may not report beam measurements for a LR-CSI report configuration by using reflection based communication. If the WTRU 200 is provided with (e.g., via RRC signaling) a configuration associated with reflection based communication and/or the reflection based communication is activated (e.g., via RRC signaling, MAC-CE indication, DCI indication) by the base station (e.g., gNB), the WTRU 200 may report beam measurements for a LR-CSI report configuration (e.g., CRI of beam with highest measured signal quality) by using reflection based communication.

The WTRU 200 may report beam measurements based on reflection based communication. For example, the WTRU 200 may report beam measurements to the base station (e.g., gNB) via reflection based communication based on one or more of the following. The WTRU 200 may determine to report beam measurements by using reflection based communication (e.g., backscatter communication) based on proximity to the base station or gNB. For example, the WTRU 200 may determine whether the WTRU 200 is sufficiently close to the base station (e.g., gNB) for using reflection based communication based on beam measurements. For example, the WTRU 200 may measure signal quality (e.g., L1-RSRP) of a set of preconfigured (e.g., via one or more RRC signaling, MAC-CE indication, DCI indicator) LP-SSs. If the highest measured signal quality (e.g., L1-RSRP) among measured LP-SSs≥a preconfigured (e.g., via one or more RRC signaling, MAC-CE indication, DCI indication) threshold, the WTRU 200 may determine to use reflection based communication for reporting beam measurements. If the highest measured signal quality (e.g., L1-RSRP) among measured LP-SSs <the preconfigured threshold, the WTRU 200 may determine not to use reflection based communication for beam reporting. The WTRU 200 that determines not to use reflection based communication may skip reporting beam measurements. Alternatively, the WTRU 200 may wake-up and use MR for beam reporting.

The WTRU 200 may report beam measurements in a configured time window by reflecting a gNB transmitted signal based on the information to be reported. For example, the WTRU 200 may reflect gNB transmitted signals with different starting times (e.g., an offset with respect to starting time of the reflection window), duration, reflection/modulation patterns (on-off patterns), etc., based on information to be reported. In an example configuration, the WTRU 200 may measure the signal quality (e.g., L1-RSRP) of LR beams associated with a LR-CSI report configuration. The WTRU 200 may determine the identity of a beam (best beam) with the highest signal quality (e.g., L1-RSRP) based on the measurements. The WTRU 200 may report the determined best beam to the base station (e.g., gNB) by reflecting a gNB transmitted signal depending on the identity of the best beam.

The WTRU 200 may receive a starting time and/or duration from the base station (e.g., gNB) for each beam associated with the LR-CSI report configuration. The WTRU 200 may select a starting time and/or duration based on the determined best beam and may reflect gNB transmitted signals during a reflection window. If the determined best beam is a first LR beam, the WTRU 200 may start reflecting a gNB transmitted signal from first starting time (e.g., first offset with respect to starting time of the reflection window) and continue reflecting the signal for a first duration. If beam with highest signal quality is a second LR beam, the WTRU 200 may start reflecting a gNB transmitted signal from a second starting time (e.g., second offset with respect to starting time of the reflection window) and continue reflecting signal for a second duration.

The WTRU 200 may receive a reflection/modulation pattern (e.g., on-off pattern) from the base station (e.g., gNB) for each beam associated with the LR-CSI report configuration. The WTRU 200 may reflect/modulate a transmitted signal by the base station (e.g., gNB) using a reflection/modulation pattern selected based on the determined best beam. If the determined best beam is the first LR beam, the WTRU 200 may reflect/modulate a gNB transmitted signal based on the first reflection/modulation pattern. If the determined best beam is the second LR beam, the WTRU 200 may reflect/modulate a gNB transmitted signal based on a second reflection/modulation pattern.

The WTRU 200 may report beam measurements by using configured UL resources. For example, upon detecting an occurrence of a LR-WTRUIBR event, the WTRU 200 may wake-up the MR and may report beam measurements (e.g., beam report for LR-URIBR event, beam report associated with one or more MR-CSI report) to the base station (e.g., gNB) by using the MR. To this end, the WTRU 200 may use one or more of the following solutions. In one solution, the WTRU 200 may request for a second UL resource for beam reporting based on a preconfigured first UL resource. In an example configuration, the WTRU 200 may be configured with a first UL resource (e.g., PUCCH). The WTRU 200 may the wake-up the MR and indicate to the base station or gNB the detection of a LR-WTRUIBR event, the availability of beam measurements to be reported (e.g., LR-WTRUIBR and/or beam report associated with MR-CSI report configuration) and/or reports detected for a LR-WTRUIBR event via the first UL resource.

Upon transmitting an indication or a report in the first UL resource, the WTRU 200 may monitor for and receive a DCI with CRC scrambled by a preconfigured (e.g., preconfigured via one or more RRC signaling, MAC-CE indication, DCI indication) RNTI) within a preconfigured (via one or more RRC signaling, MAC-CE indication, DCI indication) time window. If the WTRU 200 successfully (determined based on CRC check) receives a DCI within a configured time window, the WTRU 200 may determine a configuration/indication for a second UL resource (e.g., PUCCH, PUSCH) based on the received DCI. Using the second UL resource received, the WTRU 200 may transmit beam measurements to the base station (e.g., gNB). If the WTRU 200 fails to receive a DCI within the configured time window, the WTRU 200 may skip transmitting beam measurements to the base station (e.g., gNB). he

The WTRU 200 may be preconfigured (e.g., via one or more RRC signaling, MAC-CE indication, DCI indication) with two (e.g., periodic) UL resources (e.g., first PUCCH resource, and second PUCCH resource). Upon detecting a LR-WTRUIBR event, the WTRU 200 may wake-up the MR and may transmit an indication via first UL resource to the base station (e.g., gNB) indicating that the WTRU 200 is occupying the next occurrence of a second PUCCH resource for beam reporting. Subsequently, the WTRU 200 may transmit a beam report via the next occurrence of second PUCCH resource.

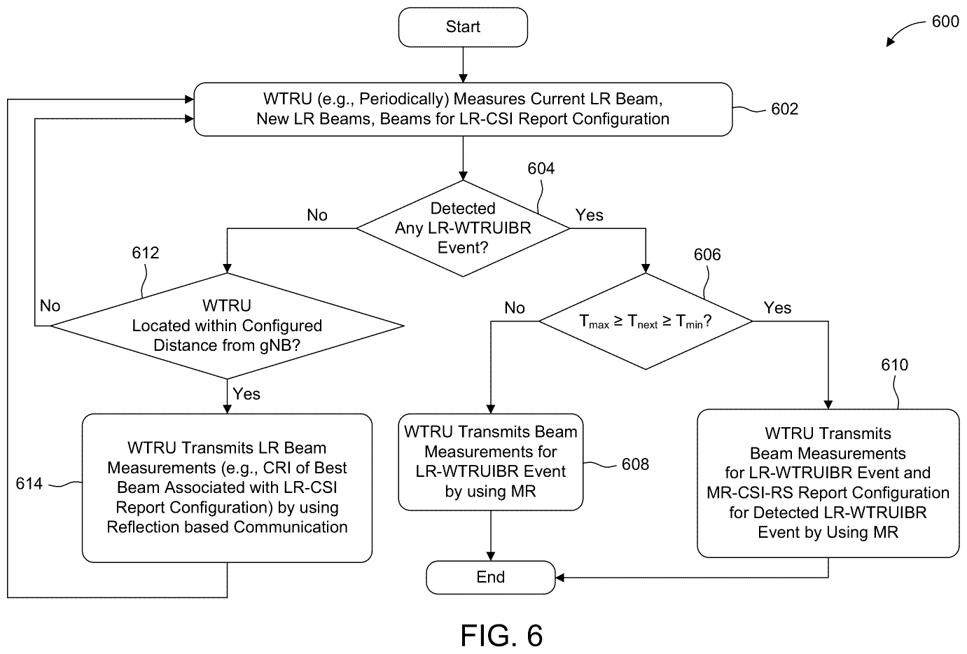

Referring now to FIG. 6, a flow diagram of a method 600 is illustrated for detecting a beam reporting event based on low power radio (LR) beam measurements, in accordance with an exemplary implementation. The method 600 may be implemented by a WTRU (e.g., WTRU 200). The WTRU may be configured with a first radio or MR (e.g., a main radio 202) and a second radio or LR (e.g., a low power radio 204). The method 600 may enable the WTRU 200 to monitor LP signals for detecting events for WTRU-initiated beam reporting based on LR beam measurements. Upon detecting an event based on the LR beam measurements, the WTRU 200 may transmit the LR beam measurements and/or MR beam measurements. Transmitting the MR beam measurements may be conditioned on time to receive/measure MR beams since detecting an event for WTRUIBR.

The WTRU may receive, from a network or base station (e.g., a gNB), first configuration information for monitoring signals using the first radio. The first configuration information may be associated with of one or more MR measurements. For example, the WTRU may receive one or more channel state information (CSI) report configurations associated with MR measurements (e.g., first and second MR-CSI report configuration associated with reporting M1 and M2 beams, where M1<M2). The WTRU may also, receive from the network or the base station, second configuration information for monitoring signals using the second radio. The second configuration information may be associated with one or more LR measurements. For example, the WTRU may receive a CSI report configuration (e.g., a LR-CSI report configuration) associated with LR measurements.

The WTRU 200 may also receive one or more of the following configurations/indications from the base station (e.g., gNB): one or more events for a WTRUIBR based on LR measurements (e.g., a first LR-WTRUIBR event: signal quality of a current LR beam<first threshold; and a second LR-WTRUIBR event: the signal quality of a current LR beam>a first threshold and the signal quality of N(≥1) new LR beams>the current LR beam); a first MR UL resource (e.g., periodic) for requesting a second MR UL resource for beam reporting; a beam reporting time window (e.g., WTRU specific) for reflection based communication (e.g., backscatter communication) and a threshold on a maximum distance to the base station (e.g., gNB) to use reflection based communication; and a first threshold (Tₘᵢₙ) and a second threshold (Tₘₐₓ) on time to receive RSs associated with MR-CSI reporting configurations from the detection a LR-WTRUIBR event.

At block 602, the WTRU may (e.g., periodically) measure a current LR beam, new LR beams, and beams for a LR-CSI report configuration. For example, the WTRU may start LP signal monitoring based on an indication and/or configuration received from the base station (e.g., gNB). While monitoring for LP signals, the WTRU may measure the quality (e.g., L1-reference signal received power(RSRP)) of a current LR beam and new LR beams. Based on the measured beam quality, the WTRU may determine if any LR-WTRUIBR events occurred at block 604.

The WTRU may determine to report beam measurements via the LR or transmit a beam report (e.g., beam report for LR-WTRUIBR event) associated with the detected LR-WTRUIBR event via the MR based on detecting or not detecting a LR-WTRUIBR event. For example, if the WTRU detects an LR-WTRUIBR event at block 604, the WTRU may transmit a beam report for the LR-WTRUIBR event by using the MR. The WTRU may transmit a beam report associated with an MR-CSI report configuration based on a time (Tₙₑₓₜ) to receive a next MR RSs associated with MR-CSI report configurations.

At block 606, the WTRU may determine whether Tₘₐₓ≥Tₙₑₓₜ≥Tₘᵢₙ. When Tₙₑₓₜ<Tₘᵢₙ or Tₙₑₓₜ>Tₘₐₓ (see FIGS. 3 and 4), the WTRU may transmit a beam report or beam measurements for the LR-WTRUIBR event using the MR at block 608. For example, the WTRU may wake-up the MR and may request a MR UL resource to transmit a beam report for the LR-WTRUIBR event by using a first MR UL resource. The WTRU may receive a second UL resource from the base station (e.g., gNB) and may transmit the beam report in the received second MR UL resources.

When the WTRU determines that Tₘₐₓ≥Tₙₑₓₜ≥Tₘᵢₙ at block 606 (see FIG. 5), the WTRU may transmit, at block 610, a beam report or beam measurements for the LR-WTRUIBR event and a beam report based on a MR-CSI report configuration among a set of MR-CSI report configurations determined based on the detected LR-WTRUIBR event. If the WTRU detects an event, the WTRU may transmit the LR-WTRUIBR and a MR beam report associated with the MR-CSI report configuration for the detected event. For example, the WTRU may wake-up the MR and may measure MR RSs for the kth MR-CSI report configuration. Using a first MR UL resource, the WTRU may request resources to transmit the LR-WTRUIBR and the MR beam report. The WTRU may receive a second MR UL resource from the base station (e.g., gNB) and may transmit the LR-WTRUIBR and the MR beam report in the received second MR UL resource.

At block 604, if the WTRU does not detect an LR-WTRUIBR event, the WTRU may determine, at block 612, whether the WTRU is located within a configured distance from the base station (e.g., gNB) (e.g., determined based on the highest LR beam quality). The WTRU may indicate a best beam (e.g., beam with highest L1-RSRP) associated with a LR-CSI report configuration by using reflection based communication (e.g., backscatter transmission) in a transmission window. For example, the WTRU may modulate a transmitted signal by the base station (e.g., gNB) based on the identity of the best beam. If the WTRU is located within a particular distance from the base station at block 612, the WTRU may transmit LR beam measurements by using the LR. For example, the WTRU may indicate the best LR beam based on reflection based communication.

Referring again to FIG. 2, the WTRU 200 may initiate beam reporting based on events detected by using LR and MR beam measurements. To determine occurrence of events for WTRUIBR based on LR beam measurements and/or events for WTRUIBR based on MR measurements (MR-WTRUIBR events), the WTRU may receive one or more of the following configurations and/or indications (e.g., via one or more of RRC signaling, MAC-CE indication, DCI indication). For example, the WTRU 200 may receive MR beams (e.g., a current MR beam and new MR beams) for detecting the occurrence of one or more events (MR-WTRUIBR events) associated with WTRUIBR based on MR beam measurements.

The WTRU 200 may receive configuration for a current MR beam and one or more new MR beams from the base station (e.g., gNB) (e.g., via one or more of RRC signaling, MAC-CE indication, DCI indication). In an example, the WTRU 200 may be configured with a set of MR beam (e.g., a CSI-RS resource set associated with MR). The WTRU 200 may determine a current MR beam and new MR beams from a configured set of MR beams based on preconfigured (e.g., via one or more of RRC signaling, MAC-CE indication, DCI indication) rule or a rule known to both the base station (e.g., gNB) and the WTRU 200 (e.g., a rule known to both the base station (e.g., gNB) and the WTRU 200 based on specifications).

The WTRU 200 may receive (e.g., via one or more of RRC signaling, MAC-CE indication, DCI indication) a set of SSBs or CSI-RSs. For example, the WTRU 200 may receive a bit map where each bit in the bitmap corresponds to a SSB in an SSB burst/a set of SSBs transmitted. The WTRU 200 may determine a SSB in the set of SSBs to be the current MR beam. Alternatively, the WTRU 200 may determine last SSB in the set of SSBs to be the current MR beam. The WTRU 200 may determine the remaining SSBs in the configured set of SSBs to be new MR beams.

The WTRU 200 may receive configuration of a set of MR beams (e.g., a CSI resource set) and a local ID (e.g., CRI, SSBRI) of current MR beam among the configured set of MR beams. The WTRU 200 may determine beam corresponding to configured local WTRU ID as a current MR beam. The WTRU 200 may determine remaining beams (beam in set of MR beams except determined current MR beam) among a configured set of MR beams as new MR beams.

The WTRU 200 may determine current and new MR beams based on indicated or configured or activated TCI states (e.g., TCI state for monitoring and receiving PDCCHs and activated/configured TCI states for the WTRU 200). For example, the WTRU 200 may determine a MR beam or MR RS configured with quasi co-location (QCL) type set to ‘typeD’ in the activated TCI state (e.g., for monitoring and receiving PDCCHs) as current MR beam. The WTRU 200 may determine MR beams or MR RSs configured with quasi co-location (QCL) type set to ‘typeD’ in the activated/configured TCI states (e.g., activated/configured TCI states for the WTRU 200 except TCI state configured for PDCCH reception) as new MR beams.

The WTRU 200 may also receive one or more MR-WTRUIBR events (e.g., first MR-WTRUIBR event, second MR-WTRUIBR event, etc.) and/or LR beams (current LR beam and new LR beams) for detecting the occurrence of one or more events (LR-WTRUIBR events) based on LR beam measurements. For example, the WTRU 200 may determine a current LR beam based on a current MR beam and preconfigured (e.g., via one or more of RRC signaling, MAC-CE indication, DCI indication) association between LR and MR beams. The WTRU 200 may determine a new LR beams based on new MR beams and preconfigured (e.g., via one or more of RRC signaling, MAC-CE indication, DCI indication) association between LR and MR beams.

Further, the WTRU 200 may receive one or more LR-WTRUIBR events (e.g., first LE-WTRUIBR event, second LR-WTRUIBR event, etc.) and/or a configuration of a beam report to be transmitted upon detecting occurrence of one or more WTRUIBR events (e.g., MR-WTRUIBR event and/or LR-WTRUIBR event). For example, the WTRU 200 may be configured with a beam report (beam report for MR-WTRUIBR event) which may include beam measurements of MR beams (e.g., current MR beam, one or more new MR beams) and beam report (beam report for LR-WTRUIBR event) which may include measurements of LR beams (e.g., current LR beam, one or more new LR beams).

Additionally, the WTRU 200 may receive first and/or second UL resources and/or one or more LR-WTRUIBR first threshold (T1) and second threshold (T2) on time to receive a current MR beam and new MR beams from detecting an LR-WTRUIBR event. For example, the WTRU 200 may semi-statically configured with first and second UL resources (e.g., first and second PUCCH resources) via RRC signaling. In an example, the WTRU 200 may be semi-statically configured with a first UL resource (e.g., first PUCCH resource) from the base station (e.g., gNB). The WTRU 200 may dynamically receive a configuration for a second UL resource (e.g., PUCCH, PUSCH) based on an indication (e.g., 1 bit indication in a PUCCH indicating occurrence of an event for beam reporting) transmitted via a first UL resource.

The WTRU 200 may also receive configurations and/or indications (e.g., via one or more of RRC signaling, MAC-CE indication, DCI indication) for starting to monitor LP signals (e.g., monitor for and receive LP signals (e.g., LP-WUS, LP-SS)). Upon receiving a configuration and/or an indication, the WTRU 200 may start monitoring a LP-WUS (e.g., starting from the first LP-WUS occasion occurs at least after a preconfigured time from receiving indication and/or configuration), and LP-SSs which may include current and new LR beams.

As used herein, ‘beam report for LR-WTRUIBR event’ may be used to refer a beam measurement report associated with a LR-WTRUIBR event. The beam report for a LR-WTRUIBR event may consist of a measured beam quality of a current LR beam, and/or a measured beam quality of new LR beams and/or detected LR-WTRUIBR events, etc. As used herein, ‘beam report for MR-WTRUIBR event’ may be used to refer a beam measurement report associated with a MR-WTRUIBR event. The beam report for MR-WTRUIBR event may consist of a measured beam quality of current MR beam, and/or measured beam quality of new MR beams and/or detected MR-WTRUIBR events, etc. As used herein, transmitting beam report for a MR-WTRUIBR event and beam report for a LR-WTRUIBR event may be used to refer transmitting beam measurements associated with a beam report for a MR-WTRUIBR event and beam measurements for a LR-WTRUIBR event. Beam measurements of two WTRUIBR events (i.e., LP-WTRUIBR event and MR-WTRUIBR event) may be transmitted together in as a single beam report or two separate beam reports.

The WTRU 200 may determine occurrence of LR-WTRUIBR events based on one or more of the following solutions. In a solution, while monitoring LP-WUS, the WTRU 200 may (e.g., periodically) measures signal quality (e.g., L1-RSRP) of current LR beam and one or more new LR beams. Based on measured signal quality (e.g., L1-RSRP) of current LR beam and one or more new LR beams, the WTRU 200 may determine the occurrence of configured one or more LR-WTRUIBR events (e.g., first LR-WTRUIBR event, second LR-WTRUIBR event).

The WTRU 200 may determine the occurrence of first LR-WTRUIBR event based one (e.g., periodically) measured signal quality of current LR beam and a preconfigured (e.g., via one or more of RRC signaling, MAC-CE indication, DCI indication) threshold. In an example, the WTRU 200 may determine that first LR-WTRUIBR event has occurred if measured signal quality of current LR beam is lower than a preconfigured (e.g., via one or more of RRC signaling, MAC-CE indication, DCI indication) first beam quality threshold a preconfigured (e.g., via one or more of RRC signaling, MAC-CE indication, DCI indication) number (≥1) of consecutive occasions the WTRU 200 monitor LR beams.

The WTRU 200 may determine the number of instances measured signal quality (e.g., L1-RSRP) of current LR beam falls below first beam quality threshold within a preconfigured (e.g., via one or more of RRC signaling, MAC-CE indication, DCI indication) time window (e.g., a moving time window in the immediate past defined in terms of number of LR beam monitoring occasions, ms, number of slots, frames, or symbols, etc.). If the number of detected instances exceeds a preconfigured (e.g., via one or more of RRC signaling, MAC-CE indication, DCI indication) threshold, the WTRU 200 may determine that first LR-WTRUIBR event has occurred.

The WTRU 200 may determine the occurrence of second LR-WTRUIBR event based on (e.g., periodically) measured signal quality (e.g., L1-RSRP) of current LR beam, measured signal quality (e.g., L1-RSRP) of one or more new LR beams, and second beam quality thresholds (e.g., preconfigured via one or more of RRC signaling, MAC-CE indication, DCI indication), and threshold on number of beams N (e.g., preconfigured via one or more of RRC signaling, MAC-CE indication, DCI indication). In an example, the WTRU 200 may determine the number of consecutive instances signal quality (e.g., L1-RSRP) of at least N number of new LR beams exceed signal quality (e.g., L1-RSRP) of current LR beam while signal quality (e.g., L1-RSRP) of current LR beam exceeds second beam quality threshold. If the number of detected consecutive instances exceeds a preconfigured (e.g., via one or more of RRC signaling, MAC-CE indication, DCI indication) threshold, the WTRU 200 may determine that second LR-WTRUIBR event has occurred.

The WTRU 200 may determine the number of instances signal quality (e.g., L1-RSRP) of at least N number of new LR beams exceeds signal quality (e.g., L1-RSRP) of current LR beam while signal quality (e.g., L1-RSRP) of current LR beam exceeds second beam quality threshold within a preconfigured (e.g., via one or more of RRC signaling, MAC-CE indication, DCI indication) time window (e.g., a moving time window in the immediate past defined in terms of number of LR beam monitoring occasions, ms, number of slots, frames, or symbols, etc.). If the number of detected instances exceeds a preconfigured (e.g., via one or more of RRC signaling, MAC-CE indication, DCI indication) threshold, the WTRU 200 may determine that second LR-WTRUIBR event has occurred. If the WTRU 200 determines occurrence of more than one LR-WTRUIBR event simultaneously, the WTRU 200 may select one event among detected LR-WTRUIBR events based on a preconfigured (e.g., via one or more of RRC signaling, MAC-CE indication, DCI indication) priority of each detected LR-WTRUIBR event. The WTRU 200 may use selected LR-WTRUIBR event for further beam monitoring operations (e.g., detecting MR-WTRUIBR events and/or for beam reporting).

The WTRU 200 monitoring LP-WUS may determine occurrence of MR-WTRUIBR events based on signal quality of current MR beam and new MR beams. To this end, the WTRU 200 may use one or more of the following solutions. In a solution, upon detecting an LR-WTRUIBR event, the WTRU 200 may monitor for occurrence of MR-WTRUIBR events based on detection of LR-WTRUIBR event and/or detected LR-WTRUIBR event (e.g., first LR-WTRUIBR evet, second LR-WTRUIBR event), and/or time to receive new and current MR beams.

The WTRU 200 may monitor for occurrence of MR-WTRUIBR events upon detecting an LR-WTRUIBR event. In an example, upon detecting an LR-WTRUIBR event, the WTRU 200 may wake-up MR and monitor for occurrence of MR-WTRUIBR events for a preconfigured duration. For example, the WTRU 200 may start a preconfigured (e.g., via one or more of RRC signaling, MAC-CE indication, DCI indication) timer after a preconfigured (e.g., via one or more of RRC signaling, MAC-CE indication, DCI indication) offset from detecting an LR-WTRUIBR event. While timer is running, the WTRU 200 may measure current MR beam and new MR beams. Based on measured signal quality of current MR beam and new MR beams, the WTRU 200 may determine the occurrence of MR-WTRUIBR events.

The WTRU 200 may receive (e.g., via one or more RRC signaling, MAC-CE indication, DCI indication) a threshold for beam quality of current MR beam. The WTRU 200 may determine that first MR-WTRUIBR event has occurred if measured signal quality of current MR beam is lower than the preconfigured threshold. For example, the WTRU 200 may receive (e.g., via one or more RRC signaling, MAC-CE indication, DCI indication) a threshold for beam quality (e.g., L1-RSRP) of current MR beam and threshold for number (M≥1) MR beams exceeding signal quality (e.g., L1-RSRP) of current MR beam. The WTRU 200 may determine that second MR-WTRUIBR event has occurred if the WTRU 200 determines that measured signal quality of current MR beam exceeds second threshold for beam quality and signal quality (e.g., L1-RSRP) of at least M new MR beams exceed measured signal quality (e.g., L1-RSRP) of current MR beam.

When monitoring for MR-WTRUIBR events, the WTRU 200 may continue to determine the occurrence of MR-WTRUIBR events until the timer expires or the WTRU 200 detects occurrence of an MR-WTRUIBR event, whichever comes first. If the WTRU 200 determines occurrence of more than one MR-WTRUIBR event simultaneously, the WTRU 200 may select one event among detected MR-WTRUIBR events based on a preconfigured (e.g., via one or more of RRC signaling, MAC-CE indication, DCI indication) priority of each detected MR-WTRUIBR event. The WTRU 200 may use selected MR-WTRUIBR event for further beam monitoring operations (e.g., for beam reporting).

Upon detecting an LR-WTRUIBR event, the WTRU 200 may monitor for occurrence of MR-WTRUIBR events depending on the detected LR-WTRUIBR event. If the WTRU 200 detected the occurrence of first LR-WTRUIBR event, the WTRU 200 may wakes-up MR and monitor for occurrence of MR-WTRUIBR events. If the WTRU 200 detected the occurrence of second LR-WTRUIBR event, the WTRU 200 may not start to monitor for occurrence of MR-WTRUIBR events.

Upon detecting an LR-WTRUIBR event, the WTRU 200 may monitor for occurrence of MR-WTRUIBR events based on time (T_{RS-MR-WTRUIBR}) to receive current MR beam and new MR beams (e.g., time to receive the first or last beam among current MR beam and new MR beams) from the detection of an LR-WTRUIBR event. If T₂≥T_{RS-MR-WTRUIBR}≥T₁, the WTRU 200 may monitor for occurrence of MR-WTRUIBR events. If T_{RS-MR-WTRUIBR}<T₁ or T_{RS-MR-WTRUIBR}>T₂, the WTRU 200 may not monitor for occurrence of MR-WTRUIBR events.

When only configured for monitoring occurrence of MR-WTRUIBR events, the WTRU 200 may wake-up MR for determining occurrence of MR-WTRUIBR events while performing LP signaling monitoring. While operating in LP mode, the WTRU 200 may periodically wake-up MR for a preconfigured (e.g., via one or more of RRC signaling, MAC-CE indication, DCI indication) duration at a time and may measure current MR beam and new MR beams. Based on measured signal quality (e.g., L1-RSRP) of current MR beam and new MR beams, the WTRU 200 may determine the occurrence of MR-WTRUIBR events.

While operating in LP mode, the WTRU 200 may wake-up MR for determining the occurrence of MR-WTRUIBR events based on measured signal quality of LR. For example, while operating in LP mode, the WTRU 200 may (e.g., periodically) measure one or more preconfigured (e.g., via one or more of RRC signaling, MAC-CE indication, DCI indication) LR beams. If signal quality of one or more (e.g., all) configured LR beams is lower than a preconfigured (e.g., via one or more of RRC signaling, MAC-CE indication, DCI indication) threshold, the WTRU 200 may wake-up MR for a preconfigured (e.g., via one or more of RRC signaling, MAC-CE indication, DCI indication) duration and may measure current MR beam and new MR beams. Based on the measured signal quality (e.g., L1-RSRP) of current MR beam and new MR beams, the WTRU 200 may determine the occurrence of MR-WTRUIBR events.

The WTRU 200 may report beam measurement based on detecting LR-WTRUIBR event and/or MR-WTRUIBR event. For example, the WTRU 200 may determine whether to transmit MR beam measurements (beam report for MR-WTRUIBR event) and/or LR beam measurements (beam report for LR-WTRUIBR event) based on detected LR-WTRUIBR events and/or MR-WTRUIBR events. When the WTRU 200 determines occurrence of MR-WTRUIBR events upon detecting occurrence of an LR-WTRUIBR events, the WTRU 200 may report beam measurement reports based on one or more of the following solutions.

In a solution, the WTRU 200 may transmit a beam report based on whether the WTRU 200 only detected an LR-WTRUIBR event or the WTRU 200 detected occurrence of an LR-WTRUIBR event and an MR-WTRUIBR event. If the WTRU 200 only detected occurrence of an LR-WTRUIBR event, the WTRU 200 may not transmit any beam report. If the WTRU 200 detected occurrence of an LR-WTRUIBR event and an MR-WTRUIBR event, the WTRU 200 may transmit a beam report for MR-WTRUIBR event. If the WTRU 200 only detected occurrence of an LR-WTRUIBR event, the WTRU 200 may transmit a beam report for LR-WTRUIBR event. If the WTRU 200 detected occurrence of an LR-WTRUIBR event and an MR-WTRUIBR event, the WTRU 200 may transmit a beam report for MR-WTRUIBR event. If the WTRU 200 only detected occurrence of an LR-WTRUIBR event, the WTRU 200 may transmit a beam report for LR-WTRUIBR event. If the WTRU 200 detected occurrence of an LR-WTRUIBR event and an MR-WTRUIBR event, the WTRU 200 may transmit a beam report for MR-WTRUIBR event and a beam report for LR-WTRUIBR event. If the WTRU 200 only detected occurrence of an LR-WTRUIBR event, the WTRU 200 may wake-exit LP signal monitoring and may indicate exiting LP signal monitoring to the base station (e.g., gNB) (e.g., transmitting a 1 bit indication in a PUCCH). If the WTRU 200 detected occurrence of an LR-WTRUIBR event and an MR-WTRUIBR event, the WTRU 200 may transmit a beam report for MR-WTRUIBR event. the base station (e.g., gNB) may determine the WTRU 200 exiting LP signal monitoring based on reception of a beam report for MR-WTRUIBR.

In a solution, the WTRU 200 may determine whether to transmit a beam report based on detected MR-WTRUIBR event if any MR-WTRUIBR event is detected. If the WTRU 200 detected first MR-WTRUIBR event, the WTRU 200 may transmit at least a beam report for MR-WTRUIBR event (e.g., a beam report for MR-WTRUIBR event only, or a beam report for MR-WTRUIBR event and beam report for LR-WTRUIBR event if detected any LR-WTRUIBR event). If the WTRU 200 detected second MR-WTRUIBR event, the WTRU 200 may not transmit any beam report.

In a solution, the WTRU 200 may determine beam report to transmit (e.g., a beam report for a LR-WTRUIBR event only, a beam report for a MR-WTRUIBR event only, a beam report for a MR-WTRUIBR event and a beam report for a LR-WTRUIBR event) based on the detected MR-WTRUIBR event (i.e., whether first MR-WTRUIBR event was detected or second MR-WTRUIBR event was detected) if any MR-WTRUIBR is detected. If the WTRU 200 detected first MR-WTRUIBR event, the WTRU 200 may transmit a beam report for MR-WTRUIBR event and a beam report for LR-WTRUIBR event if any LR-WTRUIBR is detected. If the WTRU 200 detected second MR-WTRUIBR event, the WTRU 200 may transmit only a beam report for MR-WTRUIBR event.

In a solution, the WTRU 200 may determine beam report to transmit (e.g., an LR-WTRUIBR only, an MR-WTRUIBR only, an MR-WTRUIBR and an LR-WTRUIBR) based on detected LR-WTRUIBR event (i.e., whether first LR-WTRUIBR event was detected or second LR-WTRUIBR event was detected) when an MR-WTRUIBR is detected. If the WTRU 200 detected first LR-WTRUIBR event, the WTRU 200 may transmit an MR-WTRUIBR and an LR-WTRUIBR. If the WTRU 200 detected second LR-WTRUIBR event, the WTRU 200 may transmit an LR-WTRUIBR. If the WTRU 200 detected first LR-WTRUIBR event, the WTRU 200 may exit LP signal monitoring and indicates exiting LP signal monitoring to the base station (e.g., gNB) (e.g., the WTRU 200 send a 1 bit indication in a preconfigured (e.g., one or more RRC signaling, MAC-CE indication, DCI indication) PUCCH resource). If the WTRU 200 detected second LR-WTRUIBR event, the WTRU 200 may transmit an LR-WTRUIBR.

In a solution, the WTRU 200 may determine whether to transmit a beam report and/or beam report to transmit (e.g., an LR-WTRUIBR only, an MR-WTRUIBR only, an MR-WTRUIBR and an LR-WTRUIBR) based on detected LR-WTRUIBR event (i.e., whether first LR-WTRUIBR event was detected or second LR-WTRUIBR event was detected) and detected MR-WTRUIBR event (i.e., whether first MR-WTRUIBR event was detected or second MR-WTRUIBR event was detected) if any MR-WTRUIBR is detected. If the WTRU 200 detected first LR-WTRUIBR evet only, the WTRU 200 may transmit a beam report for LR-WTRUIBR event. If the WTRU 200 detected second LR-WTRUIBR event only, the WTRU 200 may not transmit any beam report. If the WTRU 200 detected first LR-WTRUIBR event and first MR-WTRUIBR event, the WTRU 200 may transmit beam report for LR-WTRUIBR event. If the WTRU 200 detected first LR-WTRUIBR event and second MR-WTRUIBE event, the WTRU 200 may transmit a beam report for LR-WTRUIBR and a beam report for MR-WTRUIBR event. If the WTRU 200 detected second LR-WTRUIBR event and first MR-WTRUIBR event, the WTRU 200 may transmit a beam report for MR-WTRUIBR event. If the WTRU 200 detected second LR-WTRUIBR event and second MR-WTRUIBE event, the WTRU 200 may transmit a beam report for MR-WTRUIBR.

In a solution, when the WTRU 200 only detects an LR-WTRUIBR event, the WTRU 200 may determine whether to transmit an LR-WTRUIBR or whether to report detected LR-WTRUIBR event (i.e., whether first or second LR-WTRUIBR event was detected) based on detected LR-WTRUIBR event. If detected LR-WTRUIBR event is a first LR-WTRUIBR event, the WTRU 200 wakes-up and transmits a beam report for LR-WTRUIBR event. If detected LR-WTRUIBR event is a second LR-WTRUIBR event, the WTRU 200 may indicate detected event to the base station (e.g., gNB). For example, the WTRU 200 may transmit an indication (e.g., 1 bit indication in a PUCCH) to the base station (e.g., gNB) by using next occurrence of first UL resource.

The WTRU 200 may hold indicating detected LR-WTRUIBR event to the base station (e.g., gNB) (e.g., until the WTRU 200 is waken-up based on an indication received via LP-WUS/WTRU wakes-up for CSI reporting/WTRU wakes-up for UL RS (e.g., SRS) transmission/WTRU exit LP signal monitoring due to detection of a configured exit condition, the WTRU 200 wakes up to transmit a beam report upon detecting a first LR-WTRUIBR event, etc.). For example, from the last event based beam report (e.g., based on detecting first LR-WTRUIBR event), the WTRU 200 may record number of times occurrence of second LR-WTRUIBR event was detected. The WTRU 200 may report (e.g., via a PUCCH) number of times second LR-WTRUIBR event was detected upon waking-up MR.

When only configured for detecting MR-WTRUIBR events, the WTRU 200 may determine to transmit beam report for a MR-WTRUIBR event based on whether an MR-WTRUIBR event is detected, detected MR-WTRUIBR event (i.e., first MR-WTRUIBR event or second MR-WTRUIBR event) if any event is detected, and signal quality of LR. If the WTRU 200 detects an MR-WTRUIBR event (i.e., first MR-WTRUIBR event or second MR-WTRUIBR event) and signal quality (e.g., L1-RSRP) of a set of preconfigured (e.g., preconfigured via one or more of RRC signaling, MAC-CE indication, DCI indication) LR beams (e.g., all configured LR beams) is lower than a preconfigured (e.g., preconfigured via one or more of RRC signaling, MAC-CE indication, DCI indication) threshold, the WTRU 200 may transmit a beam report for MR-WTRUIBR event. If signal quality of set of LR beams is higher than or equals to threshold and the WTRU 200 detected first MR-WTRUIBR event, the WTRU 200 may transmit a beam report for MR-WTRUIBR event. If signal quality of set of LR beams (e.g., at least one beam in the LR beam set) is higher than or equals to threshold and the WTRU 200 detected second MR-WTRUIBR event, the WTRU 200 may not transmit any MR-WTRUIBR.

The WTRU 200 may report Beam Measurement by Using Configured UL resources. For example, when the WTRU 200 determines to transmit beam report(s) based on detection of an LR-WTRUIBR event and/or MR-WTRUIBR event, the WTRU 200 may wake-up MR and report beam measurements (e.g., beam report for LR-URIBR event, beam report associated with one or more MR-CSI report) to the base station (e.g., gNB). To this end, the WTRU 200 may use one or more of the following solutions.

In a solution, the WTRU 200 may request for second UL resource for beam reporting based on preconfigured first UL resource. In an example configuration, the WTRU 200 may be configured with first UL resource (e.g., PUCCH). The WTRU 200 may wakes-up MR and may indicate to gNB detection of an LR-WTRUIBR event and/or availability of beam measurements to be reported (e.g., a beam report for a LR-WTRUIBR event and/or a beam report for a MR-WTRUIBR event) and/or reports detected LR-WTRUIBR event and/or detected MR-WTRUIBR event by using first UL resource.

Upon transmitting an indication/a report in first UL resource, the WTRU 200 may monitor for and receive a DCI with CRC scrambled by a preconfigured (e.g., preconfigured via one or more RRC signaling, MAC-CE indication, DCI indication) RNTI) within a preconfigured (via one or more RRC signaling, MAC-CE indication, DCI indication) time window. If the WTRU 200 successfully (determined based on CRC check) receives a DCI within configured time window, the WTRU 200 may determine configuration/indication for a second UL resource (e.g., PUCCH, PUSCH) based on the received DCI. Using second UL resource received, the WTRU 200 may transmit beam measurements (e.g., a beam report for an LR-WTRUIBR event, and/or a beam report for an MR-WTRUIBR event) to the base station (e.g., gNB). If the WTRU 200 fails to receive a DCI within configured time window, the WTRU 200 may skip transmitting beam measurements to the base station (e.g., gNB).

In a solution, the WTRU 200 may be preconfigured (e.g., via one or more RRC signaling, MAC-CE indication, DCI indication) with two (e.g., periodic) UL resources (e.g., first PUCCH resource, and second PUCCH resource). Upon detecting an LR-WTRUIBR event, the WTRU 200 may wakes-up MR and transmits an indication via a first UL resource to the base station (e.g., gNB) indicating that the WTRU 200 is occupying next occurrence of second PUCCH resource for beam reporting. Subsequently, the WTRU 200 may transmit a beam report via next occurrence of the second PUCCH resource.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

### Abbreviations and Acronyms

ACK Acknowledgement
BLER Block Error Rate
BWP Bandwidth Part
C-DRX Connected mode DRX
CE Control Element
CG Configured grant or cell group
CP Cyclic Prefix
CP-OFDM Conventional OFDM (relying on cyclic prefix)
CQI Channel Quality Indicator
CQI Channel Quality Information
CRC Cyclic Redundancy Check
CRI CSI-RS Resource Indicator
CSI Channel State Information
CSI Channel State Information
DCI Downlink Control Information
DCI Downlink Control Information
DFI Downlink feedback information
DG Dynamic grant
DL Downlink
DM-RS Demodulation Reference Signal
DRB Data Radio Bearer
DRX Discontinuous Reception
HARQ Hybrid Automatic Repeat Request
LI Layer Indicator
LP Low Power
LO LP-WUS occasions
LR Low power Radio
LTE Long Term Evolution e.g. from 3GPP LTE R8 and up
MAC Medium Access Control
MCS Modulation and Coding Scheme
MIMO Multiple Input Multiple Output
MO LP-WUS Monitoring Occasion
MR Main Radio
NACK Negative ACK
NR New Radio
NW Network
OFDM Orthogonal Frequency-Division Multiplexing
P(U/
Physical Uplink/Downlink Control Channel
D)CCH
P(U/
Physical Uplink/Downlink Shared Channel
D)SCH
PBCH Physical Broadcast Channel
PHY Physical Layer
PMI Precoding Matrix Indicator
PO Paging Occasion
PRACH Physical Random Access Channel
PSS Primary Synchronization Signal
RA Random Access (or procedure)
RACH Random Access Channel
RAR Random Access Response
RCU Radio access network Central Unit
RF Radio Front end
RI Rank Indicator
RLF Radio Link Failure
RLM Radio Link Monitoring
RNTI Radio Network Identifier
RO RACH occasion
RRC Radio Resource Control
RRM Radio Resource Management
RRM Radio Resource Management
RS Reference Signal
RS Reference Signal
RSRP Reference Signal Received Power
RSRP Reference Signal Received Power
RSSI Received Signal Strength Indicator
SDU Service Data Unit
SPS Semi-persistent scheduling
SRS Sounding Reference Signal
SRS Sounding Reference Signal
SS Synchronization Signal
SS Synchronization Signal
SSBRI SS/PBCH Resource Block Indicator
SSS Secondary Synchronization Signal
SUL Supplemental Uplink
SWG Switching Gap (in a self-contained subframe)
TB Transport Block
TBS Transport Block Size
TRP Transmission/Reception Point
TSC Time-sensitive communications
TSN Time-sensitive networking
UL Uplink
URLLC Ultra-Reliable and Low Latency Communications
WBWP Wide Bandwidth Part
   Wireless Local Area Networks and related technologies (IEEE
WLAN
   802.xx domain)
WUR Wake up Radio
WUS Wake up Signal

What is claimed:

1. A method implemented by a wireless transmit/receive unit (WTRU) having a first radio and a second radio, the method comprising:
receiving, from a network, first configuration information for monitoring signals using the first radio;
receiving, from the network, second configuration information for monitoring signals using the second radio;
monitoring one or more reference signals received by the second radio based on the second configuration information;
performing at least one measurement of the one or more references signals received by the second radio;
detecting an occurrence of a beam reporting event based on the at least one measurement of the one or more reference signals;
determining a time period from the occurrence of the beam reporting event to receive a next reference signal at the first radio based on the first configuration information; and
transmitting, via the first radio, a beam report for the beam reporting event to the network based on a comparison of the time period to a time threshold.

2. The method of claim 1, wherein the first radio comprises a main radio (MR) or transceiver, wherein the second radio comprises a low power radio (LR) or transceiver, wherein the first configuration information is based on MR beam measurements and comprises a channel state information (CSI) report configuration for the first radio, and wherein the second configuration information is based on LR beam measurements and comprises a CSI report configuration for the second radio.

3. The method of claim 1, wherein the at least one measurement comprises a reference signal received power (RSRP) or a reference signal received quality (RSRQ).

4. The method of claim 1, further comprising:
receiving at least one threshold; and
comparing the at least one measurement of the one or more reference signals to the at least one threshold, wherein the occurrence of the beam reporting event is detected based on the comparison.

5. The method of claim 4, wherein the first configuration information, the second configuration information, and the at least one threshold is received via RRC signaling, MAC-CE indication, or DCI indication.

6. The method of claim 1, further comprising:
receiving at least one threshold;
determining a first quality of a first reference signal of the one or more reference signals; and
comparing the first quality of the first reference signal to the at least one threshold, wherein the occurrence of the beam reporting event is detected based at least in part on a determination that the first quality of the first reference signal is less than the at least one threshold.

7. The method of claim 1, further comprising:
receiving at least one threshold;
determining a first quality of a first reference signal of the one or more reference signals;
determining a second quality of a second reference signal of the one or more reference signals;
comparing the first quality of the first reference signal to the at least one threshold; and
comparing the first quality of the first reference signal to the second quality of the second reference signal, wherein the occurrence of the beam reporting event is based on a determination that the first quality of the first reference signal is greater than the at least one threshold and the second quality of the second reference signal is greater that the first quality of the first reference signal.

8. The method of claim 1, further comprising:
receiving a first time threshold and a second time threshold; and
comparing the time period to the first time threshold and to the second time threshold, wherein the beam report for the beam reporting event is transmitted to the network based on a determination that the time period is less than the first time threshold or is greater than the second time threshold.

9. The method of claim 8, wherein the first time threshold is a minimum time threshold to receive the next reference signal at the first radio based on the first configuration information, and wherein the second time threshold is a maximum time threshold to receive the next reference signal at the first radio based on the first configuration information.

10. The method of claim 1, wherein the beam report for the beam reporting event is transmitted using at least one UL resource of the first radio.

11. The method of claim 1, further comprising:
receiving a first time threshold and a second time threshold;
comparing the time period to the first time threshold and to the second time threshold;
determining a second beam report according to the first configuration information for the first radio based on the occurrence of the beam reporting event;
determining that the time period is greater than or equal to the first time threshold and less than or equal to the second time threshold;
wake-up the first radio; and
transmitting, via the first radio, the second beam report to the network based on the determination, wherein the beam report for the beam reporting event is also transmitted, via the first radio, to the network based on the determination.

12. The method of claim 1, further comprising:
determining a non-occurrence of the beam reporting event based on the at least one measurement of the one or more reference signals.

13. The method of claim 12, further comprising:
determining that the WTRU is within a particular distance from the network; and
transmitting, via the second radio, beam measurements to the network during a time window using reflection based communication, wherein the beam measurements are associated with the second radio.

14. A wireless transmit/receive unit (WTRU) comprising:
a first radio;
a second radio; and
a processor configured to:
receive, from a network, first configuration information for monitoring signals using the first radio;
receive, from the network, second configuration information for monitoring signals using the second radio;
monitor one or more reference signals received by the second radio based on the second configuration information;
determine at least one measurement of the one or more references signals received by the second radio;
detect an occurrence of a beam reporting event based on the at least one measurement of the one or more reference signals;
determine time period from the occurrence of the beam reporting event to receive a next reference signal at the first radio based on the first configuration information; and
transmit, via the first radio, a beam report for the beam reporting event to the network based on a comparison of the time period to a time threshold.

15. The WTRU of claim 14, wherein the first radio comprises a main radio (MR) or transceiver, wherein the second radio comprises a low power radio (LR) or transceiver, wherein the first configuration information is based on MR beam measurements and comprises a channel state information (CSI) report configuration for the first radio, and wherein the second configuration information is based on LR beam measurements and comprises a CSI report configuration for the second radio.

16. The WTRU of claim 14, wherein the processor is further configured to:
receive at least one threshold; and
compare the at least one measurement of the one or more reference signals to the at least one threshold, wherein the occurrence of the beam reporting event is detected based on the comparison.

17. The WTRU of claim 14, wherein the processor is further configured to:
receive at least one threshold;
determine a first quality of a first reference signal of the one or more reference signals; and
compare the first quality to the at least one threshold, wherein the occurrence of the beam reporting event is detected based at least in part on a determination that the first quality of the first reference signal is less than the at least one threshold.

18. The WTRU of claim 14, wherein the processor is further configured to:
receive at least one threshold;
determine a first quality of a first reference signal of the one or more reference signals;
determine a second quality of a second reference signal of the one or more reference signals;
compare the first quality of the first reference signal to the at least one threshold; and
compare the first quality of the first reference signal to the second quality of the second reference signal, wherein the occurrence of the beam reporting event is based on a determination that the first quality of the first reference signal is greater than the at least one threshold and the second quality of the second reference signal is greater that the first quality of the first reference signal.

19. The WTRU of claim 14, wherein the processor is further configured to:
receive a first time threshold and a second time threshold; and
compare the time period to the first time threshold and to the second time threshold, wherein the beam report for the beam reporting event is transmitted to the network based on a determination that the time period is less than the first time threshold or is greater than the second time threshold.

20. The WTRU of claim 14, wherein the processor is further configured to:
receive a first time threshold and a second time threshold;
compare the time period to the first time threshold and to the second time threshold;
determine a second beam report according to the first configuration information for the first radio based on the occurrence of the beam reporting event;
determine that the time period is greater than or equal to the first time threshold and less than or equal to the second time threshold;
wake-up the first radio; and
transmit, via the first radio, the second beam report to the network based on the determination, wherein the beam report for the beam reporting event is also transmitted, via the first radio, to the network based on the determination.
